(19) United States
(12) Patent Application Publication
(10) Pub. No.: US 2022/0101407 A1
(43) Pub. Date: Mar. 31, 2022

(54) METHOD FOR DETERMINING A RECOMMENDED PRODUCT, ELECTRONIC APPARATUS, AND NON-TRANSITORY COMPUTER-READABLE STORAGE MEDIUM

(71) Applicant: BOE TECHNOLOGY GROUP CO., LTD., Beijing (CN)

(72) Inventors: Jingtao XU, Beijing (CN); Tingting WANG, Beijing (CN)

(21) Appl. No.: 17/458,815

(22) Filed: Aug. 27, 2021

(30) Foreign Application Priority Data
Sep. 30, 2020 (CN) 202011065861.X

(51) Int. Cl. G06Q 30/06; G06F 16/9535; G06Q 30/02; G06K 9/00

(52) U.S. Cl. CPC G06Q 30/0631; G06K 9/00362; G06Q 30/0271; G06F 16/9535

(57) ABSTRACT

Some embodiments of the present disclosure provide a method for determining a recommended product, including steps of: acquiring an image of a user; determining at least one appearance attribute of the user according to the image of the user; determining appearance grade information of the user according to the at least one appearance attribute of the user; and determining a corresponding recommended product according to the appearance grade information of the user. Some embodiments of the present disclosure also provide an electronic apparatus and a non-transitory computer-readable storage medium.

### CROSS REFERENCE TO RELATED APPLICATIONS

The present application claims the priority of the Chinese Patent Application No. 202011065861.X filed on Sep. 30, 2020, the content of which is incorporated herein by reference in its entirety.

### TECHNICAL FIELD

Some embodiments of the present disclosure relate to the field of image analysis technology, and in particular, to a method for determining a recommended product, an electronic apparatus, and a non-transitory computer-readable storage medium.

### BACKGROUND

In the related technology, products may be pushed to users through advertisements (e.g., television advertisements, web advertisements, etc.). But the preferences of different users for products vary greatly, and therefore, users are hardly actually interested in most of the products in the advertisements that are pushed to them.

### SUMMARY

Some embodiments of the present disclosure provide a method for determining a recommended product, an electronic apparatus, and a non-transitory computer-readable storage medium.

In a first aspect, some embodiments of the present disclosure provide a method for determining a recommended product, including steps of: acquiring an image of a user; determining at least one appearance attribute of the user according to the image of the user; determining appearance grade information of the user according to the at least one appearance attribute of the user; and determining a corresponding recommended product according to the appearance grade information of the user.

In some embodiments of the present disclosure, the image of the user includes an image of a face of the user.

In some embodiments of the present disclosure, after the step of determining appearance grade information of the user according to the at least one appearance attribute of the user, the method further includes steps of: determining a label of the user according to the appearance grade information and/or the at least one appearance attribute of the user.

In some embodiments of the present disclosure, the step of determining at least one appearance attribute of the user according to the image of the user includes a step of: processing the image of the user by using a neural network to determine the at least one appearance attribute of the user.

In some embodiments of the present disclosure, the neural network is a ShuffleNet v2 lightweight network.

In some embodiments of the present disclosure, the step of determining appearance grade information of the user according to the at least one appearance attribute of the user includes steps of: determining a sub-parameter value corresponding to each of the at least one appearance attribute of the user according to the appearance attribute to obtain at least one sub-parameter value of the at least one appearance attribute of the user, wherein there is a preset Gaussian distribution relationship between the appearance attribute and the sub-parameter value; and determining the appearance grade information of the user according to the at least one sub-parameter value of the at least one appearance attribute of the user.

In some embodiments of the present disclosure, the step of determining a sub-parameter value corresponding to each of the at least one appearance attribute of the user according to the appearance attribute comprises a step of: determining yi of an appearance attribute i of the user according to the following formula, and determining the sub-parameter value of the appearance attribute i according to yi: yi=yiₘₐₓ*exp[−(xi−xiₘ)²/Si]; where exp[ ] represents an exponential function with a natural constant e as a base, yiₘₐₓ represents a preset maximum sub-parameter value of the appearance attribute i, xi represents a value of the appearance attribute i, xiₘ represents a preset peak value of a Gaussian distribution relationship corresponding to the appearance attribute i, and Si represents a full width at half maximum value of the Gaussian distribution relationship corresponding to the appearance attribute i.

In some embodiments of the present disclosure, the step of determining the sub-parameter value of the appearance attribute i according to yi includes steps of: taking the sub-parameter value as yi when yi does not meet a preset first exclusion rule; the first exclusion rule includes: taking the sub-parameter value as a first threshold when yi is less than the first threshold; and/or, taking the sub-parameter value as a second threshold when yi is greater than the second threshold, wherein the second threshold is greater than the first threshold.

In some embodiments of the present disclosure, the step of determining the appearance grade information of the user according to the at least one sub-parameter values of the at least one appearance attribute of the user comprises a step of: determining the appearance grade information of the user as a weighted average or a sum of the at least one sub-parameter value of the at least one appearance attribute.

In some embodiments of the present disclosure, the step of determining the appearance grade information of the user according to the at least one sub-parameter value of the at least one appearance attribute of the user comprises steps of: determining an intermediate parameter value according to the at least one sub-parameter value of the at least one appearance attribute of the user; and taking the appearance grade information as the intermediate parameter value when the intermediate parameter value does not meet a preset second exclusion rule; the second exclusion rule includes: taking the sub-parameter value as a third threshold when the intermediate parameter value is less than the third threshold; and/or, taking the sub-parameter value as a fourth threshold when the intermediate parameter value is greater than the fourth threshold, wherein the fourth threshold is greater than the third threshold.

In some embodiments of the present disclosure, the step of determining a corresponding recommended product according to the appearance grade information of the user includes a step of: determining product grade information of the recommended product according to the appearance grade information of the user, wherein there is a positive correlation between the appearance grade information and the product grade information.

In some embodiments of the present disclosure, the at least one appearance attribute comprises at least one of: gender, age, face shape, expression, glasses, hairstyle, beard, skin color, hair color, height, body shape, and clothing.

In some embodiments of the present disclosure, after the step of determining a label of the user, the method further includes a step of: pushing the recommended product and the label of the user to the user.

In a second aspect, some embodiments of the present disclosure provide an electronic apparatus, including: one or more processors; a memory having one or more computer-executable instructions stored thereon; one or more I/O interfaces between the one or more processors and the memory, and configured to enable information interaction between the one or more processors and the memory; the one or more computer-executable instructions, when executed by the one or more processors, cause the one or more processors to perform steps of: acquiring an image of a user; determining at least one appearance attribute of the user according to the image of the user; determining appearance grade information of the user according to the at least one appearance attribute of the user;

and determining a corresponding recommended product according to the appearance grade information of the user.

In some embodiments of the present disclosure, the one or more computer-executable instructions, when executed by the one or more processors, further cause the one or more processors to perform steps of: after the step of determining appearance grade information of the user according to the at least one appearance attribute of the user, determining a label of the user according to the appearance grade information and/or the at least one appearance attribute of the user; and after the step of determining a label of the user, pushing the recommended product and the label of the user to the user.

In some embodiments of the present disclosure, the step of determining at least one appearance attribute of the user according to the image of the user includes steps of: processing the image of the user by using a neural network to determine the at least one appearance attribute of the user; wherein the step of determining appearance grade information of the user according to the at least one appearance attribute of the user includes steps of: determining a sub-parameter value corresponding to each of the at least one appearance attribute of the user according to the appearance attribute to obtain at least one sub-parameter value of the at least one appearance attribute of the user, wherein there is a preset Gaussian distribution relationship between the appearance attribute and the sub-parameter value; determining the appearance grade information of the user according to the at least one sub-parameter value of the at least one appearance attribute of the user; wherein the step of determining a corresponding recommended product according to the appearance grade information of the user includes steps of: determining product grade information of the recommended product according to the appearance grade information of the user, wherein there is a positive correlation between the appearance grade information and the product grade information.

In some embodiments of the present disclosure, the step of determining a sub-parameter value corresponding to each of the at least one appearance attribute of the user according to the appearance attribute comprises steps of: determining yi of an appearance attribute i of the user according to the following formula, and determining the sub-parameter value of the appearance attribute i according to yi: yi=yi max*exp[−(xi−xiₘ)²/Si]; where exp[ ] represents an exponential function with a natural constant e as a base, yiₘₐₓ represents a preset maximum sub-parameter value of the appearance attribute i, xi represents a value of the appearance attribute i, xiₘ represents a preset peak value of a Gaussian distribution relationship corresponding to the appearance attribute i, and Si represents a full width at half maximum value of the Gaussian distribution relationship corresponding to the appearance attribute i; wherein the step of determining the sub-parameter value of the appearance attribute i according to yi includes steps of: taking the sub-parameter value as yi when yi does not meet a preset first exclusion rule; the first exclusion rule includes: taking the sub-parameter value as a first threshold when yi is less than the first threshold; and/or, taking the sub-parameter value as a second threshold, when yi is greater than the second threshold, wherein the second threshold is greater than the first threshold; wherein the step of determining the appearance grade information of the user according to the at least one sub-parameter value of the at least one appearance attribute of the user comprises steps of: determining an intermediate parameter value according to the at least one sub-parameter value of the at least one appearance attribute of the user; and taking the appearance grade information as the intermediate parameter value when the intermediate parameter value does not meet a preset second exclusion rule; the second exclusion rule includes: taking the sub-parameter value as a third threshold when the intermediate parameter value is less than the third threshold; and/or, taking the sub-parameter value as a fourth threshold when the intermediate parameter value is greater than the fourth threshold, wherein the fourth threshold is greater than the third threshold.

In a third aspect, some embodiments of the present disclosure provide a non-transitory computer-readable storage medium having stored thereon computer-executable instructions that, when executed by a processor, perform steps of: acquiring an image of a user; determining at least one appearance attribute of the user according to the image of the user; determining appearance grade information of the user according to the at least one appearance attribute of the user; and determining a corresponding recommended product according to the appearance grade information of the user.

In some embodiments of the present disclosure, the step of determining at least one appearance attribute of the user according to the image of the user includes steps of: processing the image of the user by using a neural network to determine the at least one appearance attribute of the user; wherein the step of determining appearance grade information of the user according to the at least one appearance attribute of the user includes steps of: determining a sub-parameter value corresponding to each of the at least one appearance attribute of the user according to the appearance attribute to obtain at least one sub-parameter value of the at least one appearance attribute of the user, wherein there is a preset Gaussian distribution relationship between the appearance attribute and the sub-parameter value; determining the appearance grade information of the user according to the at least one sub-parameter value of the at least one appearance attribute of the user;

wherein the step of determining a corresponding recommended product according to the appearance grade information of the user includes steps of: determining product grade information of the recommended product according to the appearance grade information of the user, wherein there is a positive correlation between the appearance grade information and the product grade information.

In some embodiments of the present disclosure, the step of determining a sub-parameter value corresponding to each of the at least one appearance attribute of the user according to the appearance attribute comprises steps of: determining yi of an appearance attribute i of the user according to the following formula, and determining the sub-parameter value of the appearance attribute i according to yi: yi=yiₘₐₓ*exp[−(xi−xiₘ)²/Si]; where exp[ ] represents an exponential function with a natural constant e as a base, yiₘₐₓ represents a preset maximum sub-parameter value of the appearance attribute i, xi represents a value of the appearance attribute i, xiₘ represents a preset peak value of a Gaussian distribution relationship corresponding to the appearance attribute i, and Si represents a full width at half maximum value of the Gaussian distribution relationship corresponding to the appearance attribute i; wherein the step of determining the sub-parameter value of the appearance attribute i according to yi includes steps of: taking the sub-parameter value as yi when yi does not meet a preset first exclusion rule; the first exclusion rule includes: taking the sub-parameter value as a first threshold when yi is less than a first threshold; and/or, taking the sub-parameter value as a second threshold when yi is greater than a second threshold, wherein the second threshold is greater than the first threshold; wherein the step of determining the appearance grade information of the user according to the at least one sub-parameter value of the at least one appearance attribute of the user includes steps of: determining an intermediate parameter value according to the at least one sub-parameter value of the at least one appearance attribute of the user; and taking the appearance grade information as the intermediate parameter value when the intermediate parameter value does not meet a preset second exclusion rule; the second exclusion rule includes: taking the sub-parameter value as a third threshold when the intermediate parameter value is less than the third threshold; and/or, taking the sub-parameter value as a fourth threshold when the intermediate parameter value is greater than the fourth threshold, wherein the fourth threshold is greater than the third threshold.

### BRIEF DESCRIPTION OF DRAWINGS

Drawings are included to provide a further understanding of some embodiments of the present disclosure, constitute a part of the specification, and explain the present disclosure together with some embodiments of the present disclosure, but do not limit the present disclosure. The above and other features and advantages will become more apparent to one of ordinary skill in the art by describing in detail exemplary embodiments with reference to the drawings, in which:

FIG. 1 is a flow chart of a method for determining a recommended product according to some embodiments of the present disclosure;

FIG. 2 is a flow chart of a method for determining a recommended product according to some embodiments of the present disclosure;

FIG. 3 is a schematic structural diagram of a convolutional neural network used in a method for determining a recommended product according to some embodiments of the present disclosure;

FIG. 4 is a block diagram of a device for determining a recommended product according to some embodiments of the present disclosure;

FIG. 5 is a block diagram of an electronic apparatus according to some embodiments of the present disclosure;

FIG. 6 is a block diagram of a non-transitory computer-readable storage medium according to some embodiments of the present disclosure; and

FIG. 7 is a block diagram of an exemplary computing system according to an embodiment of the present disclosure.

### DETAIL DESCRIPTION OF EMBODIMENTS

In order to make one of ordinary skill in the art better understand the technical solution of the present disclosure, a method for determining a recommended product, an electronic apparatus, and a non-transitory computer-readable storage medium provided in some embodiments of the present disclosure are described in detail below with reference to the drawings.

Some embodiments of the present disclosure will be described more fully hereinafter with reference to the drawings, but the embodiments shown may be embodied in different forms and should not be construed as limited to the embodiments set forth herein. Rather, these embodiments are provided so that this disclosure will be thorough and complete, and will fully convey the scope of the present disclosure to one of ordinary skill in the art.

Some embodiments of the present disclosure may be described with reference to plan and/or cross-sectional views by way of idealized schematic illustrations of the present disclosure. Accordingly, the example illustrations may be modified in accordance with manufacturing techniques and/or tolerances.

Embodiments of the present disclosure and features of the embodiments may be combined with each other without conflict.

The terms used in the present disclosure are only used for describing particular embodiments and are not intended to limit the present disclosure. As used in this disclosure, the term “and/or” includes any and all combinations of one or more associated listed items. As used in this disclosure, the singular forms “a”, “an” and “the” are intended to include the plural forms as well, unless the context clearly indicates otherwise. The terms “including,” “comprising,” “made of,” as used in this disclosure, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used in this disclosure have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense, unless expressly so defined herein.

Some embodiments of the present disclosure are not limited to the embodiments shown in the drawings, but include modifications of configurations formed based on manufacturing processes. Thus, regions illustrated in the drawings have schematic properties, and their shapes illustrate specific shapes of regions of elements, but are not intended to be limiting.

In the related technology, products may be pushed to users through advertisements (e.g., television advertisements, web advertisements, etc.). But the preferences of different users for products vary greatly, and therefore, users are hardly actually interested in most of the products in the advertisements that are pushed to them, which results in low efficiency and serious waste of product pushing.

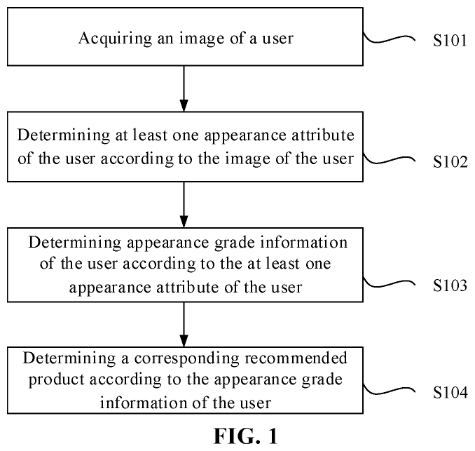

FIG. 1 is a flow chart of a method for determining a recommended product according to some embodiments of the present disclosure. In a first aspect, with reference to FIG. 1, some embodiments of the present disclosure provide a method for determining a recommended product, including steps of:

S101, acquiring an image of a user. In some embodiments of the present disclosure, the image of the user includes an image of the face of the user.

An image of the user to be recommended with a product (the image of the user) is acquired. Since a face (a facial region) is a part of the human body whose appearance information is most abundant, the image of the user should include at least the image of the face of the user.

Alternatively, in other embodiments of the present disclosure, the image of the user may also include images of other parts of the user's body. For example, the image of the user may include an image of the head of the user, an image of the upper/lower body of the user, or an image of the whole body of the user, and the like.

In some embodiments of the present disclosure, the image of the user is acquired in various manners. For example, in some embodiments of the present disclosure, the image of the user may be directly taken by an image acquisition unit (e.g., a camera). Alternatively, in other embodiments of the present disclosure, the data of the acquired image of the user (e.g., the image taken by the user with his/her mobile phone) may be acquired through a data interface.

S102, determining at least one appearance attribute of the user according to the image of the user.

The appearance of the user in the image of the user is analyzed, to determine at least one specific characteristic of the user that meets a corresponding criterion in the point of the appearance, i.e. at least one appearance attribute. Each appearance attribute characterizes a user in some particular aspect of the appearance.

In some embodiments of the present disclosure, the appearance attributes may be of different types (e.g., a round face type, an oval face type, etc.). Alternatively, in other embodiments of the present disclosure, the appearance attribute may also include a certain numerical value (e.g., a specific age value) or the like.

S103, determining appearance grade information of the user according to the at least one appearance attribute of the user.

Based on the at least one appearance attribute determined in step S102, an overall characteristic representing the appearance of the user, i.e., the appearance grade information of the user, is further calculated.

In some embodiments of the present disclosure, the appearance grade information may be in the form of a numerical value, a number, a code, or the like. In some embodiments of the present disclosure, the appearance grade information may be a “numerical value” having a certain meaning, for example, a numerical value reflecting the preference of the user for sports, or a numerical value reflecting an identity of the user, or a numerical value reflecting a face score of the user, and the like. The numerical value may be between 1 and 100, and a specific numerical value may be 80, 90, 100, and the like. Alternatively, in other embodiments of the present disclosure, the appearance grade information may also be numbers, codes, etc. without direct meaning, such as 80, 90, 100, A, B, C, etc., wherein each number, code, etc. has no direct meaning and represents only a “type” to which the appearance grade information belongs.

S104, determining a corresponding recommended product according to the appearance grade information of the user.

Based on the appearance grade information determined in step S103, it is determined which products the user having the appearance grade information should have a high probability of being interested in, and these products are determined as a recommended product.

In some embodiments, the step S104 includes steps of: determining a recommended product corresponding to a label of the user according to a preset product correspondence.

That is, a product correspondence may be set in advance, including recommended products corresponding to different appearance grade information, so that the recommended product may be determined according to the product correspondence.

For example, according to the numerical value, number, code, etc. of the appearance grade information of the user, a product suitable for the user may be obtained according to the product correspondence. For example, a numerical value of the appearance grade information of the user, which is between 1 and 5, corresponds to a first product; a numerical value of the appearance grade information of the user, which is between 6 and 10, corresponds to a second product, etc. For another example, a number of the appearance grade information of the user, which is A, corresponds to a first product; a number of the appearance grade information of the user, which is B, corresponds to a second product, etc.

In some embodiments of the present disclosure, the recommended product may be a physical product, a financial product, a service-like product, or the like.

In some embodiments of the present disclosure, the different products may be different types of products, such as sporting equipment products and financial services products. Alternatively, in other embodiments of the present disclosure, different products may the same type of product having different specific parameters. For example, different products may be loan products, but have different loan amounts, etc.

The applicant has creatively discovered that the appearance of a person is often implicitly correlated with its preferences or products suitable for him/her. For example, a person with a strong body generally prefer sports with a higher likelihood of being interested in sports products (e.g., sports equipment, fitness services, sports game videos, etc.); a person wearing formal dresses generally has higher working income and are more likely to be interested in some financing products (such as large financing products and high-risk financing products).

In some embodiments of the present disclosure, the “preferences” of the user for products are determined by analyzing the appearance of each user (the image of the user), and a product that should be recommended to the user (the recommended product) is determined according to the preferences. In this way, the recommended product obtained by some embodiments of the present disclosure have a higher probability of meeting the requirements or interests of users, so that the efficiency of the product pushing may be improved, and unnecessary waste is reduced.

In some embodiments, the appearance attributes include at least one of: gender, age, face shape, expression, glasses, hairstyle, beard, skin color, hair color, height, body shape, clothing.

The appearance attributes determined by analyzing the image of the user may include: gender (male, female), age (age value), face shape (specific type such as oval face and round face, or various types of confidence), expression (specific type such as happiness and anger, or various types of confidence), glasses (whether glasses are worn or specific type of glasses is further determined when glasses are worn), hairstyle (hair length type such as long hair, short hair and no hair, or hair style such as split hair and curly hair), beard (whether beard exists or specific type of beard is further determined when beard exists), skin color (type of color such as very white, whitish, blackish, or specific color coordinate value), hair color (hair color type such as black and golden, or specific color coordinate value), height (value of height), body shape (normal, fat, thin, strong, etc.), clothing (specific type such as T-shirt, western style clothes, jeans, etc., or types of the whole clothing such as sportswear, casual wear, etc.)

It should be understood that the above-listed appearance attributes, as well as the detailed presentation of each appearance attribute, are intended to be illustrative only, and not limit the scope of the present disclosure.

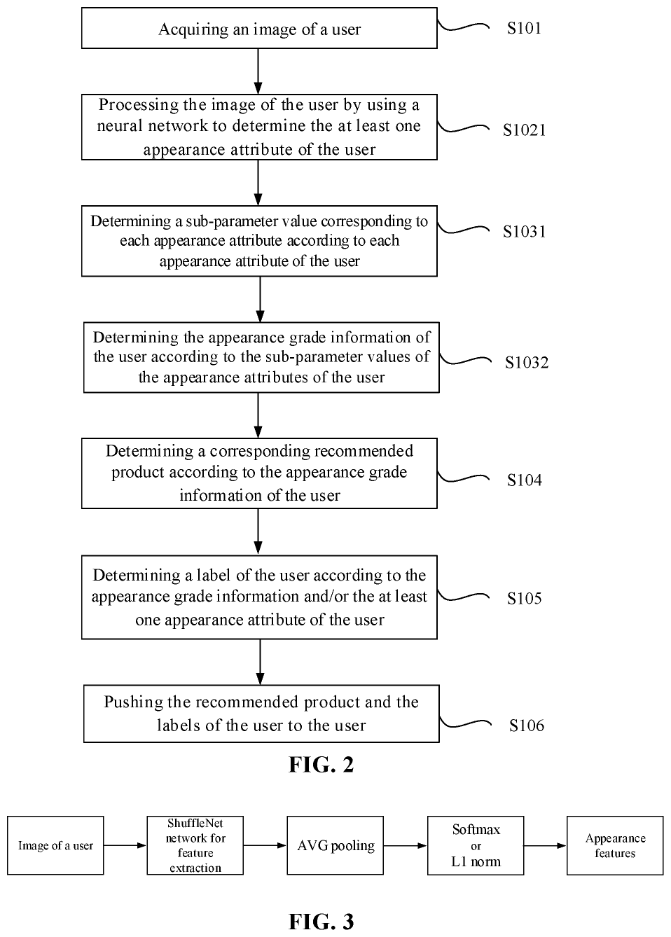

FIG. 2 is a flow chart of a method for determining a recommended product according to some embodiments of the present disclosure. In some embodiments, after determining at least one appearance attribute of the user (step S102), and after determining the appearance grade information of the user (step S103), the method further includes steps of:

S105, determining a label of the user according to the appearance grade information and/or the at least one appearance attribute of the user.

According to one or more of the determined appearance grade information and the appearance attribute, one or more “evaluations” for the user made according to the appearance of the user are determined. That is, the label of the user is determined.

In some embodiments, the label should take a form of expression that is understandable by common users, e.g., text describing characteristics of the user, e.g., “small fresh meat (handsome young boys),” “frozen age beauty,” “sports talent,” “favorite sports product,” “high income person,” etc.

In some embodiments, the step S105 may include steps of: determining a label corresponding to the appearance grade information and/or the appearance attribute of the user according to a preset label correspondence.

As an example, in some embodiments of the present disclosure, a label correspondence may be set in advance, where the label correspondence includes labels corresponding to respective appearance grade information and respective appearance attributes.

In some embodiments, in the label correspondence, there may be various specific correspondences among the appearance grade information, the appearance attribute and the label.

In some embodiments, for example, some labels may correspond to only one of the appearance grade information, the appearance attribute. For example, in a case where the appearance grade information is in different numerical value ranges, the appearance grade information may directly correspond to different labels. Alternatively, in other embodiments of the present disclosure, in a case where there is/are a specific appearance attribute(s), the appearance grade information corresponds to different labels. For example, in a case where an age value is in different ranges, the labels are provided as the elderly, the middle aged, the young, etc.

As another example, some labels may correspond to a combination of the appearance grade information and the appearance attribute. For example, only if a numerical value of the appearance grade information is within a specific range and has specific appearance attribute(s), the appearance grade information and the appearance attribute may correspond to the specific label.

In some embodiments, after determining the corresponding recommended product (step S104), and after determining the label of the user (step S105), the method further includes steps of:

S106, pushing the recommended product and the labels of the user to the user. After the recommended product and the label corresponding to the user are determined, the product and the label may be pushed (recommended) to the user in some way.

In some embodiments, the recommended product and the label may be pushed in various specific ways. For example, the recommended product and the label may be displayed to the user, or a voice of information about the recommended product and the label may be played to the user, or information about the recommended product and the label may be sent to a terminal (e.g., a mobile phone) of the user, etc., as long as the determined recommended product and label may be “informed” to the user in some way.

In some embodiments, the step of determining at least one appearance attribute of the user according to the image of the user (step S102) includes steps of:

S1021, processing the image of the user by using a neural network to determine the at least one appearance attribute of the user.

In some embodiments, the neural network includes a ShuffleNet network (one type of a convolutional neural network).

As an example, in some embodiments of the present disclosure, the image of the user may be processed with a convolutional neural network (CNN) to determine the at least one appearance attribute of the user. The convolutional neural network is an intelligent network for analyzing features of the image to determine the “classification” for the image. Thus, the above process is also equivalent to determining the “classification” satisfied by the user in the image of the user.

Further, the convolutional neural network includes a ShuffleNet network. Still further, the convolutional neural network includes a ShuffleNet v2 lightweight network.

FIG. 3 is a schematic structural diagram of a convolutional neural network used in a method for determining a recommended product according to some embodiments of the present disclosure. In some embodiments, FIG. 3 shows a process of identifying the appearance attributes by using the convolutional neural network, the input image of the user is subjected to feature extraction by the ShuffleNet network, followed by AVG pooling, and followed by Softmax (one type of a logistic regression model) or norm processing (L1 norm), to obtain output of the appearance attributes.

In some embodiments, the Softmax processing may be used for extraction of the appearance attributes (gender, expression, face shape, glasses, beard, and the like), such as face type and the like represented by confidence, and the norm processing may be used for extraction of the appearance attributes, such as age and the like having numerical value.

In some embodiments, the step of determining appearance grade information of the user according to the at least one appearance attribute of the user (S103) includes steps of:

S1031, determining a sub-parameter value corresponding to each of the at least one appearance attribute of the user according to the appearance attribute, to obtain at least one sub-parameter value of the at least one appearance attribute of the user.

In some embodiments, there is a preset Gaussian distribution relationship between each appearance attribute and the sub-parameter value.

As an example, in some embodiments of the present disclosure, each appearance attribute has a certain “numerical value”, and each appearance attribute may make a certain contribution to the “appearance grade information”, the contribution is a “sub-parameter value” of the appearance attribute. Moreover, the numerical value and the sub-parameter value of the appearance attribute meet a Gaussian distribution relationship therebetween. Therefore, the corresponding “sub-parameter value” may be calculated according to the “numerical value” of the appearance attribute and the specific Gaussian distribution relationship.

In some embodiments, the step S1031 includes: determining yi of an appearance attribute i of the user according to the following formula, and determining the sub-parameter value of the appearance attribute i according to yi:

yi=yiₘₐₓ*exp [−(xi−xiₘ)²/Si];

where exp[ ] represents an exponential function with a natural constant e as a base, yiₘₐₓ represents a preset maximum sub-parameter value of the appearance attribute i, xi represents a value of the appearance attribute i, xiₘ represents a preset peak value of a Gaussian distribution relationship corresponding to the appearance attribute i, and Si represents a full width at half maximum value of the Gaussian distribution relationship corresponding to the appearance attribute i.

Specifically, a parameter yi of any appearance attribute (the appearance attribute i) may be calculated through the above formula, and then, a sub-parameter value of the appearance attribute i is determined according to yi (for example, yi is directly used as the sub-parameter value); where xiₘ is preset, which represents a peak (mean) of the Gaussian distribution relationship corresponding to the appearance attribute i; Si is also preset, which represents a full width at half maximum value of the Gaussian distribution relationship (a Gaussian half-width value) corresponding to the appearance attribute i.

In some embodiments, determining the sub-parameter value of the appearance attribute i according to yi includes: when the yi does not meet a preset first exclusion rule, taking the sub-parameter value as yi;

The first exclusion rule includes:

Taking the sub-parameter value as a first threshold when yi is less than the first threshold;

And/or,

Taking the sub-parameter value as a second threshold when yi is greater than the second threshold.

The second threshold is greater than the first threshold.

In order to avoid that a too great or too less sub-parameter value of individual appearance attribute has a too great influence on the appearance grade information, it may be predefined that: when yi is less than the first threshold (e.g. 80) or greater than the second threshold (e.g. 100), the first threshold or the second threshold is directly used as the sub-parameter value, and otherwise, yi is used as the sub-parameter value.

S1032, determining the appearance grade information of the user according to the at least one sub-parameter value of the at least one appearance attribute of the user.

Based on the sub-parameter values of the appearance attributes calculated as described above, a parameter (the appearance grade information) indicating an appearance evaluation of the entire user is further calculated.

In some embodiments, the step S1032 includes steps of: determining the appearance grade information of the user as a weighted average or a sum of the at least one sub-parameter value of the at least one appearance attribute.

For example, a weighted average (e.g., mathematical expectation), a sum, etc., of the sub-parameter values of the respective appearance attributes may be used as the appearance grade information.

Of course, the appearance grade information obtained at this time is in the form of “numerical value”.

Alternatively, in other embodiments, the step S1032 includes steps of: Determining an intermediate parameter value according to the at least one sub-parameter value of the at least one appearance attribute of the user;

When the intermediate parameter value does not meet a preset second exclusion rule, the appearance grade information is taken as the intermediate parameter value;

The second exclusion rule includes: Taking sub-parameter value as a third threshold when the intermediate parameter value is less than the third threshold;

And/or,

Taking sub-parameter value as a fourth threshold when the intermediate parameter value is greater than the fourth threshold.

The fourth threshold is greater than the third threshold.

An intermediate parameter value (e.g., the weighted average or the sum of the sub-parameter values of the respective appearance attributes) may be determined in a certain manner according to the sub-parameter values, and is usually used as the appearance grade information; but when the intermediate parameter value is less than the third threshold (e.g., 80) or greater than the fourth threshold (e.g., 100), the third threshold or the fourth threshold is directly used as the appearance grade information.

Of course, the appearance grade information obtained at this time is in the form of “numerical value”.

In some embodiments, the step of determining a corresponding recommended product according to the appearance grade information of the user (S104) includes steps of: determining product grade information of the recommended product according to the appearance grade information of the user.

In some embodiments of the present disclosure, there is a positive correlation between the appearance grade information and the product grade information.

As an example, in some embodiments of the present disclosure, when the appearance grade information is a “numerical value”, the “product grade information” of the recommended product corresponding to the appearance grade information may be determined according to a preset proportional relationship and based on the numerical value.

As described above, different product grade information may correspond to different types of products, and may also correspond to different specific parameters of the same type of products.

For example, for a loan product, the product grade information may be a specific “loan amount”. For example, the loan amount y (in ten thousand RMB) may be calculated by the following formula:

y=ax−b;

where x is the calculated product grade information, a is a preset positive coefficient (representing positive correlation), and b is a preset coefficient.

For example, if the value of the product grade information is between 80 and 100, and a=2.5, b=−195, the available loan amount y is between 5 and 55 (in ten thousand RMB). The greater the value of the product grade information is, the greater the loan amount is (that is, they are positively correlated with each other).

Alternatively, it should be understood that other known steps may also be included in the method of some embodiments of the present disclosure. For example, the method of some embodiments of the present disclosure may include steps of prompting the user to perform an operation (e.g., prompting the user to acquire the image of the user), performing exception handling when an error occurs (e.g., the acquired image has no appearance of the user), registering and logging in by the user, collecting, counting, and analyzing data generated by processing processes for subsequent algorithm improvement (e.g., changing parameters of the above convolutional neural network, changing Gaussian distribution relationship, etc.), etc., which are not described in detail herein.

Some specific examples of the method of determining a recommended product are described below.

The method for determining a recommended product according to some embodiments of the present disclosure is performed according to an appearance image of a certain user. The image of the user includes the image of the face of the user; and the appearance attributes include gender, age, face shape, glasses, beard.

Step 1, acquiring the image of the user (the image of the face of the user).

Step 2, extracting the appearance attributes by adopting the convolutional neural network including the ShuffleNet_v2 lightweight network.

The convolutional neural network used in some embodiments of the present disclosure is pre-trained with training samples having known appearance attributes.

Step 3, determining the appearance grade information of the user according to the appearance attribute of the user.

In some embodiments of the present disclosure, the appearance attributes include age (appearance attribute 1), face shape (appearance attribute 2), and expression (appearance attribute 3).

Specifically, yi of each appearance attribute i (i=1 or 2 or 3) may be calculated by the following formula, and the sub-parameter value is determined according to yi:

yi=yiₘₐₓ*exp [−(xi−xiₘ)²/Si]

where exp[ ] represents an exponential function with a natural constant e as a base, yiₘₐₓ represents a preset maximum sub-parameter value of the appearance attribute i, xi represents a value of the appearance attribute i, xiₘ represents a preset peak value of a Gaussian distribution relationship corresponding to the appearance attribute i, and Si represents a full width at half maximum value of the Gaussian distribution relationship corresponding to the appearance attribute i.

In some embodiments of the present disclosure, the age (appearance attribute 1) is a specific age value; when y1 is calculated, the preset peak value (mean value) of the Gaussian distribution relationship is 25 years old (for female) or 30 years old (for male); the preset maximum sub-parameter value is 79 years old; an interval is 5 years old; the preset maximum sub-parameter value (second threshold) is 100; the full width at half maximum value is 70; and a preset minimum sub-parameter value (first threshold) is 80 (that is, if the calculated y1 is less than 80, the sub-parameter value is 80; if the calculated y1 is greater than 100, the sub-parameter value is 100; and if the calculated y1 is less than 100 and greater than 80, the sub-parameter value is y1).

In some embodiments of the present disclosure, the face shape (appearance attribute 2) includes 5 types, namely, a round face, a square face, a triangular face, an oval face, and a heart-shaped face, each of which has the confidence (that is, the possibility of the type, therefore, a sum of the confidences of all types is 1); when y2 is calculated, different types may be provided with different Gaussian distribution relationships. For example, a preset peak value (mean) of a certain type of Gaussian distribution relationship is 0.5; a preset maximum sub-parameter value is 1 (because the confidence cannot exceed 1); an interval is 0.1; a preset maximum sub-parameter value (second threshold) is 100; a full width at half maximum value is 70; and a preset minimum sub-parameter value (first threshold) is 80 (that is, if the calculated y2 is less than 80, the sub-parameter value is 80; if the calculated y2 is greater than 100, the sub-parameter value is 100; and if the calculated y2 is less than 100 and greater than 80, the sub-parameter value is y2).

In some embodiments of the present disclosure, the expression (appearance attribute 3) includes 7 types, namely, Angry, Disgust, Fear, Happy, Sad, Surprise, and Neutral, each of which has the confidence (or the possibility of the type, therefore, a sum of the confidences of all types is 1); when y3 is calculated, different types may be provided with different Gaussian distribution relationships. For example, a preset peak value (mean) of a certain type of Gaussian distribution relationship is 0.5; a preset maximum sub-parameter value is 1 (because the confidence cannot exceed 1); an interval is 0.1; a preset maximum sub-parameter value (second threshold) is 100; a full width at half maximum value is 70; and a preset minimum sub-parameter value (first threshold) is 80 (that is, if the calculated y3 is less than 80, the sub-parameter value is 80; if the calculated y3 is greater than 100, the sub-parameter value is 100; and if the calculated y3 is less than 100 and greater than 80, the sub-parameter value is y3).

Step 4, the mathematical expectation of the y1, the y2 and the y3 is used as the appearance grade information of the user.

The mathematical expectation (mean) E (y1, y2, y3) may be calculated by the following formula:

E(y1,y2,y3)=(y1+y2+y3)/3.

Step 5, determining at least one label of the user by combining the appearance grade information and the appearance attributes.

For example, the appearance attributes may include age, glasses, etc., such that the user's label may be determined in conjunction with the appearance grade information and the appearance attributes. For example, if the age is less than 25 years, a “young” label is given; if the appearance grade information is greater than 95 and the age is less than 25 years, a label of “small fresh meat” is given; if the appearance grade information is greater than 95, the age is greater than 35 years old, and the gender is female, a label of “frozen age beauty” is given.

Step 6, determining a corresponding recommended product according to the appearance grade information of the user.

A recommended product is determined (e.g., product grade information is calculated) based on the appearance grade information.

For example, the above products may be physical products, financial products, service products, etc., and further may be loans of a specific amount.

Step 7, pushing the recommended product and the label of the user to the user.

The determined recommended product and label of the user may be “informed” to the user in some way.

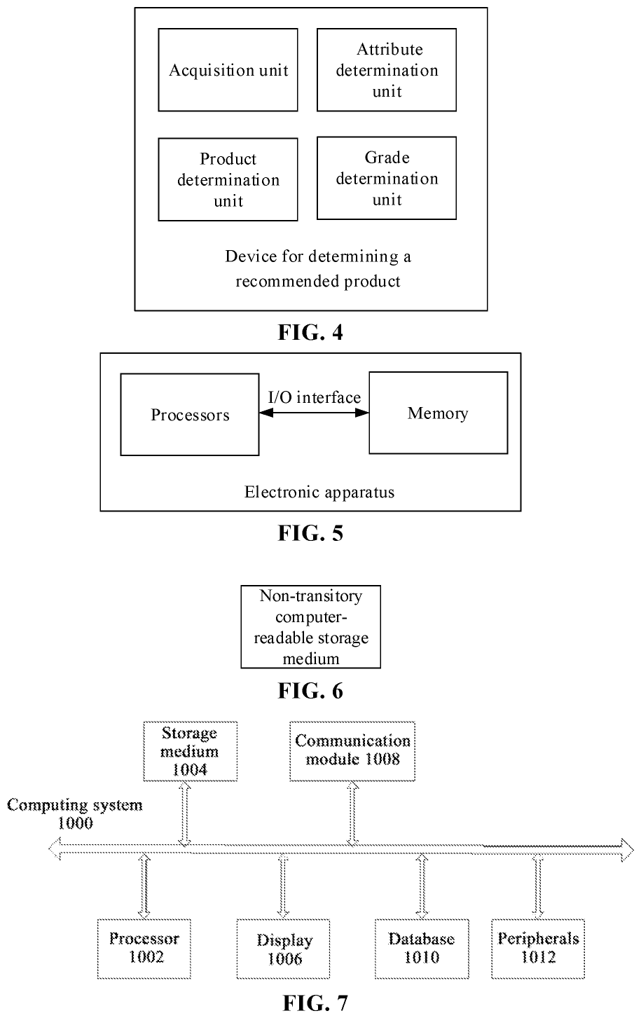

FIG. 4 is a block diagram of a device for determining a recommended product according to some embodiments of the present disclosure. In a second aspect, referring to FIG. 4, some embodiments of the present disclosure provide a device for determining a recommended product, including:

An acquisition unit configured to acquire an image of the user; the image of the user includes an image of the face of the user;

An attribute determination unit configured to determine at least one appearance attribute of the user from the image of the user;

A grade determination unit configured to determine appearance grade information of the user according to at least one appearance attribute of the user;

A product determination unit configured to determine a corresponding recommended product according to the appearance grade information of the user.

The device for determining a recommended product according to some embodiments of the present disclosure may implement any one of the above methods for determining a recommended product.

In some embodiments, the acquisition unit includes an image acquisition unit. The acquisition unit may include the image acquisition unit, such as a video camera, a camera, etc., capable of directly acquiring the image of the user.

Alternatively, in other embodiments of the present disclosure, the acquisition unit also may be a data interface for the user to acquire data of the acquired image of the user, for example, a USB interface, a wired network interface, a wireless network interface, or the like.

In some embodiments, the device for determining a recommended product of some embodiments of the present disclosure further includes:

A label determination unit configured to determine a label of the user based on the appearance grade information and/or the at least one appearance attribute of the user.

That is, there may also be the label determination unit for determining the label of the user.

In some embodiments, the device for determining a recommended product of some embodiments of the present disclosure further includes:

A pushing unit configured to push the recommended product and the label of the user to the user.

The device for determining a recommended product may further include the pushing unit for pushing the determined recommended product and the label of the user to the user. In some embodiments of the present disclosure, the pushing unit may include a display, a speaker, an information sending unit (for sending information of the recommended product and the label to a terminal of the user), and the like, as long as the determined recommended product and label of the user may be “informed” to the user in some way.

In some embodiments, the device for determining a recommended product of some embodiments of the present disclosure further includes:

An interaction unit configured to receive an instruction of a user and to deliver information to the user.

Interaction with the user may also be required to complete the process of determining a recommended product. Therefore, the device for determining a recommended product may also include the interaction unit. In some embodiments of the present disclosure, the interaction unit may be a device capable of both transmitting information and acquiring user instructions, such as a touch screen. Alternatively, in other embodiments of the present disclosure, the interaction unit may also be a combination of an input device (e.g., a keyboard, a mouse, etc.) and an output device (e.g., a display screen, a speaker, etc.).

The device for determining a recommended product according to some embodiments of the present disclosure may be installed in an operating place (e.g., a bank, a mall, etc.) for a user to operate, so as to acquire a recommended product suitable for the user. Alternatively, the device for determining a recommended product according to some embodiments of the present disclosure may be operated by a worker to determine a recommended product suitable for the user and for subsequent services for the user.

The device for determining a recommended product of some embodiments of the present disclosure may be unitary, i.e., all components of the device for determining a recommended product may be collectively disposed together. Alternatively, the device for determining a recommended product according to some embodiments of the present disclosure may be a split type, that is, all components of the device for determining a recommended product may be respectively disposed at different positions. For example, the device for determining a recommended product may include a client installed in an operation place (e.g., a bank, a mall, etc.), the client includes the acquisition unit, the interaction unit, etc. for the user to operate; the label unit, the product unit, and other units for data processing of the device for determining a recommended product may be processors disposed in the cloud.

For example, the device for determining a recommended product of some embodiments of the present disclosure may include a face recognition unit, a data statistics and analysis unit, and the like.

The following description will be made by taking an example in which the device for determining a recommended product is applied to loans. In some embodiments of the present disclosure, the face recognition unit includes two modules, that is, face registration and face recognition. After a feedback of user registration is acquired through a loan recommendation interface of the interaction unit, the face recognition unit may be turned on, that is, a camera is started for detecting the face, face features are extracted, and then, are compared with face information stored in a database for recognition; if the face recognition is successful, the user information is directly obtained and pushed to the cloud, and is managed together with the attribute information matching the user information; and if the face recognition fails, the face information of the user and the information input during user registration are simultaneously transmitted to the cloud for storing the user data, which is managed together with the attribute information matching the user data.

In some embodiments of the present disclosure, the data statistics and analysis unit transmits the identified appearance attributes and appearance grade information to the cloud for processing the user's attributes, so as to obtain gender distribution, age distribution, appearance grade information, the number of registered users, the number of users applying for loans, and the like of the user using the device, for user information analysis. Further, a basic image of the face of the user may be obtained, and then, subsequent user data maintenance and management may be carried out.

FIG. 5 is a block diagram of an electronic apparatus according to some embodiments of the present disclosure. In a third aspect, with reference to FIG. 5, some embodiments of the present disclosure provide an electronic apparatus, including:

One or more processors;

A memory having one or more computer-executable instructions stored thereon; One or more I/O interfaces connected between the processor and the memory and configured to enable information interaction between the processor and the memory;

The one or more computer-executable instructions, when executed by the one or more processors, implement any of the above methods of determining a recommended product.

In some embodiments of the present disclosure, the one or more processors are devices with data processing capabilities, including, but not limited to, a Central Processing Unit (CPU), or the like; the memory is a device having data storage capabilities, including, but not limited to, Random Access Memory (RAM, more specifically, such as SDRAM, DDR, etc.), Read Only Memory (ROM), Electrically Erasable Programmable Read Only Memory (EEPROM), FLASH; the one or more I/O interfaces (read/write interfaces) are connected between the one or more processors and the memory, and may implement information interaction between the memory and the one or more processors, and includes, but is not limited to, a data bus and the like.

FIG. 6 is a block diagram of a non-transitory computer-readable storage medium according to some embodiments of the present disclosure. In a fourth aspect, with reference to FIG. 6, some embodiments of the present disclosure provide a non-transitory computer-readable storage medium having stored thereon computer-executable instructions that, when executed by a processor, implement any of the above-described methods of determining a recommended product.

The method and the device for determining a recommended product according to an embodiment of the present disclosure may be implemented on any suitable computing circuitry platform. FIG. 7 is a block diagram of an exemplary computing system according to an embodiment of the present disclosure.

The exemplary computing system 1000 may include any appropriate type of TV, such as a plasma TV, a liquid crystal display (LCD) TV, a touch screen TV, a projection TV, a non-smart TV, a smart TV, etc. The exemplary computing system 1000 may also include other computing systems, such as a personal computer (PC), a tablet or mobile computer, or a smart phone, etc. In addition, the exemplary computing system 1000 may be any appropriate content-presentation device capable of presenting any appropriate content. Users may interact with the computing system 100 to perform other activities of interest.

As shown in FIG. 7, computing system 100 may include a processor 1002, a storage medium 1004, a display 1006, a communication module 1008, a database 1010 and peripherals 1012. Certain devices may be omitted and other devices may be included to better describe the relevant embodiments.

The processor 1002 may include any appropriate processor or processors. Further, the processor 1002 can include multiple cores for multi-thread or parallel processing. The processor 1002 may execute sequences of computer program instructions to perform various processes. The storage medium 1004 may include memory modules, such as ROM, RAM, flash memory modules, and mass storages, such as CD-ROM and hard disk, etc. The storage medium 1004 may store computer programs for implementing various processes when the computer programs are executed by the processor 1002. For example, the storage medium 1004 may store computer programs for implementing various algorithms (such as an image processing algorithm) when the computer programs are executed by the processor 1002.

Further, the communication module 1008 may include certain network interface devices for establishing connections through communication networks, such as TV cable network, wireless network, internet, etc. The database 1010 may include one or more databases for storing certain data and for performing certain operations on the stored data, such as database searching.

The display 1006 may provide information to users. The display 1006 may include any appropriate type of computer display device or electronic apparatus display such as LCD or OLED based devices. The peripherals 112 may include various sensors and other I/O devices, such as keyboard and mouse.

In the present disclosure, the terms “first,” “second,” and the like are used for descriptive purposes only and are not to be construed as indicating or implying relative importance. The term “a plurality of” means two or more unless explicitly defined otherwise. In the present disclosure, two components connected by a dotted line are in an electrical connection with each other or in a contact relationship with each other, and the dotted line is used only for the purpose of making the drawings clearer and making a solution of the present disclosure more understandable.

Other embodiments of the present disclosure will be apparent to one of ordinary skill in the art from consideration of the specification and practice of the present disclosure disclosed herein. The present disclosure is intended to cover any variations, uses, or adaptations of the present disclosure following general principles of the present disclosure and including common knowledge or customary technical means in the art which is not disclosed by the present disclosure. The specification and embodiments are considered as exemplary only, and a true scope and a spirit of the present disclosure are indicated by following claims.

The flowchart and block diagrams in the drawings illustrate architecture, functionality, and operation of possible implementations of a device, a method and a computer program product according to various embodiments of the present disclosure. In this regard, each block in the flowchart or block diagrams may represent a module, program segment(s), or a portion of a code, which includes at least one executable instruction for implementing specified logical function(s). It should also be noted that, in some alternative implementations, functions noted in the blocks may occur out of the order noted in the drawings. For example, two blocks being successively connected may, in fact, be performed substantially concurrently, or the blocks may sometimes be performed in the reverse order, depending upon the functionality involved. It will also be noted that each block of the block diagrams and/or flowchart, and combinations of blocks in the block diagrams and/or flowchart, may be implemented by special purpose hardware-based systems that perform the specified functions or operations, or combinations of special purpose hardware and computer instructions.

The components (sub-devices) involved in the embodiments of the present disclosure may be implemented by software or hardware. The described components may also be provided in a processor, for example, each of the components may be a software program provided in a computer or a mobile intelligent device, or may be a separately configured hardware device. A name of the component does not in some way limit the component itself.

One of ordinary skill in the art will appreciate that all or some of the steps, systems, functional modules/units in the devices, disclosed above may be implemented as software, firmware, hardware, and suitable combinations thereof.

In a hardware implementation, the division between functional modules/units mentioned in the above description does not necessarily correspond to the division of physical components. For example, one physical component may have multiple functions, or one function or step may be performed by several physical components in cooperation.

Some or all of the physical components may be implemented as software executed by a processor, such as a Central Processing Unit (CPU), digital signal processor, or microprocessor, or as hardware, or as an integrated circuit, such as an application specific integrated circuit. Such software may be distributed on computer readable media, which may include computer storage media (or non-transitory media) and communication media (or transitory media). The term computer storage media includes volatile and nonvolatile, removable and non-removable media implemented in any method or technology for storage of information, such as computer readable instructions, data structures, program modules or other data, as is well known to one of ordinary skill in the art. Computer storage media includes, but is not limited to, Random Access Memory (RAM, more specifically SDRAM, DDR, etc.), Read Only Memory (ROM), Electrically Erasable Programmable Read Only Memory (EEPROM), FLASH, or other disk storage; CD-ROM, Digital Versatile Disk (DVD), or other optical disk storage; magnetic cassettes, magnetic tape, magnetic disk storage or other magnetic storage; any other medium which may be used to store the desired information and which may be accessed by a computer. In addition, communication media typically embodies computer readable instructions, data structures, program modules or other data in a modulated data signal such as a carrier wave or other transport mechanism and includes any information delivery media, as is well known to one of ordinary skill in the art.

It will be understood that the present disclosure is not limited to the precise arrangements that have been described above and shown in the drawings, and that various modifications and changes may be made without departing from the scope thereof. The scope of the present disclosure is limited only by the claims. The present disclosure has disclosed example embodiments, and although specific terms are employed, they are used and should be interpreted in a generic and descriptive sense only and not for purposes of limitation. In some instances, features, characteristics and/or elements described in connection with a particular embodiment may be used alone or in combination with features, characteristics and/or elements described in connection with other embodiments, unless expressly stated otherwise, as would be apparent to one skilled in the art. Therefore, it will be understood by one of ordinary skill in the art that various changes in form and details may be made therein without departing from the scope of the present disclosure as set forth in the claims.

What is claimed is:

1. A method for determining a recommended product, comprising steps of:
acquiring an image of a user;
determining at least one appearance attribute of the user according to the image of the user;
determining appearance grade information of the user according to the at least one appearance attribute of the user; and
determining a corresponding recommended product according to the appearance grade information of the user.

2. The method of claim 1, wherein the image of the user comprises an image of a face of the user.

3. The method of claim 1, wherein after the step of determining appearance grade information of the user according to the at least one appearance attribute of the user, the method further comprises steps of:
determining a label of the user according to the appearance grade information and/or the at least one appearance attribute of the user.

4. The method of claim 3, wherein the step of determining at least one appearance attribute of the user according to the image of the user comprises a step of:
processing the image of the user by using a neural network to determine the at least one appearance attribute of the user.

5. The method of claim 4, wherein the neural network is a ShuffleNet v2 lightweight network.

6. The method of claim 4, wherein the step of determining appearance grade information of the user according to the at least one appearance attribute of the user comprises steps of:
determining a sub-parameter value corresponding to each of the at least one appearance attribute of the user according to the appearance attribute to obtain at least one sub-parameter value of the at least one appearance attribute of the user, wherein there is a preset Gaussian distribution relationship between the appearance attribute and the sub-parameter value; and
determining the appearance grade information of the user according to the at least one sub-parameter value of the at least one appearance attribute of the user.

7. The method of claim 6, wherein the step of determining a sub-parameter value corresponding to each of the at least one appearance attribute of the user according to the appearance attribute comprises a step of:
determining yi of an appearance attribute i of the user according to the following formula, and determining the sub-parameter value of the appearance attribute i according to yi:
yi=yiₘₐₓ*exp [−(xi−xiₘ)²/Si];
where exp[ ] represents an exponential function with a natural constant e as a base, yiₘₐₓ represents a preset maximum sub-parameter value of the appearance attribute i, xi represents a value of the appearance attribute i, xiₘ represents a preset peak value of a Gaussian distribution relationship corresponding to the appearance attribute i, and Si represents a full width at half maximum value of the Gaussian distribution relationship corresponding to the appearance attribute i.

8. The method of claim 7, wherein the step of determining the sub-parameter value of the appearance attribute i according to yi comprises steps of:
taking the sub-parameter value as yi when yi does not meet a preset first exclusion rule;
the first exclusion rule comprises:
taking the sub-parameter value as a first threshold when yi is less than the first threshold;
and/or,
taking the sub-parameter value as a second threshold when yi is greater than the second threshold,
wherein the second threshold is greater than the first threshold.

9. The method of claim 8, wherein the step of determining the appearance grade information of the user according to the at least one sub-parameter values of the at least one appearance attribute of the user comprises a step of:
determining the appearance grade information of the user as a weighted average or a sum of the at least one sub-parameter value of the at least one appearance attribute.

10. The method of claim 8, wherein the step of determining the appearance grade information of the user according to the at least one sub-parameter value of the at least one appearance attribute of the user comprises steps of:
determining an intermediate parameter value according to the at least one sub-parameter value of the at least one appearance attribute of the user; and
taking the appearance grade information as the intermediate parameter value when the intermediate parameter value does not meet a preset second exclusion rule;
the second exclusion rule comprises:
taking the sub-parameter value as a third threshold when the intermediate parameter value is less than the third threshold; and/or,
taking the sub-parameter value as a fourth threshold when the intermediate parameter value is greater than the fourth threshold,
wherein the fourth threshold is greater than the third threshold.

11. The method of claim 1, wherein the step of determining a corresponding recommended product according to the appearance grade information of the user comprises a step of:
determining product grade information of the recommended product according to the appearance grade information of the user, wherein there is a positive correlation between the appearance grade information and the product grade information.

12. The method of claim 1, wherein the at least one appearance attribute comprises at least one of:
gender, age, face shape, expression, glasses, hairstyle, beard, skin color, hair color, height, body shape, and clothing.

13. The method of claim 3, wherein after the step of determining a label of the user, the method further comprises a step of:
pushing the recommended product and the label of the user to the user.

14. An electronic apparatus, comprising:
one or more processors;
a memory having one or more computer-executable instructions stored thereon;
one or more I/O interfaces between the one or more processors and the memory, and configured to enable information interaction between the one or more processors and the memory;
the one or more computer-executable instructions, when executed by the one or more processors, cause the one or more processors to perform steps of:
acquiring an image of a user;
determining at least one appearance attribute of the user according to the image of the user;
determining appearance grade information of the user according to the at least one appearance attribute of the user; and
determining a corresponding recommended product according to the appearance grade information of the user.

15. The electronic apparatus of claim 14, wherein the one or more computer-executable instructions, when executed by the one or more processors, further cause the one or more processors to perform steps of:
after the step of determining appearance grade information of the user according to the at least one appearance attribute of the user, determining a label of the user according to the appearance grade information and/or the at least one appearance attribute of the user; and
after the step of determining a label of the user, pushing the recommended product and the label of the user to the user.

16. The electronic apparatus of claim 15,
wherein the step of determining at least one appearance attribute of the user according to the image of the user comprises steps of:
processing the image of the user by using a neural network to determine the at least one appearance attribute of the user;
wherein the step of determining appearance grade information of the user according to the at least one appearance attribute of the user comprises steps of:
determining a sub-parameter value corresponding to each of the at least one appearance attribute of the user according to the appearance attribute to obtain at least one sub-parameter value of the at least one appearance attribute of the user, wherein there is a preset Gaussian distribution relationship between the appearance attribute and the sub-parameter value;
determining the appearance grade information of the user according to the at least one sub-parameter value of the at least one appearance attribute of the user;
wherein the step of determining a corresponding recommended product according to the appearance grade information of the user comprises a step of:
determining product grade information of the recommended product according to the appearance grade information of the user, wherein there is a positive correlation between the appearance grade information and the product grade information.

17. The electronic apparatus of claim 16, wherein, the step of determining a sub-parameter value corresponding to each of the at least one appearance attribute of the user according to the appearance attribute comprises steps of:
determining yi of an appearance attribute i of the user according to the following formula, and determining the sub-parameter value of the appearance attribute i according to yi:
yi=yiₘₐₓ*exp[−(xi−xiₘ)²/Si];
where exp[ ] represents an exponential function with a natural constant e as a base, yiₘₐₓ represents a preset maximum sub-parameter value of the appearance attribute i, xi represents a value of the appearance attribute i, xiₘ represents a preset peak value of a Gaussian distribution relationship corresponding to the appearance attribute i, and Si represents a full width at half maximum value of the Gaussian distribution relationship corresponding to the appearance attribute i;
wherein the step of determining the sub-parameter value of the appearance attribute i according to yi comprises steps of:
taking the sub-parameter value as yi when yi does not meet a preset first exclusion rule;
the first exclusion rule comprises:
taking the sub-parameter value as a first threshold when yi is less than the first threshold;
and/or,
taking the sub-parameter value as a second threshold, when yi is greater than the second threshold,
wherein the second threshold is greater than the first threshold;
wherein the step of determining the appearance grade information of the user according to the at least one sub-parameter value of the at least one appearance attribute of the user comprises steps of:
determining an intermediate parameter value according to the at least one sub-parameter value of the at least one appearance attribute of the user; and
taking the appearance grade information as the intermediate parameter value when the intermediate parameter value does not meet a preset second exclusion rule;
the second exclusion rule comprises:
taking the sub-parameter value as a third threshold when the intermediate parameter value is less than the third threshold;
and/or,
taking the sub-parameter value as a fourth threshold when the intermediate parameter value is greater than the fourth threshold,
wherein the fourth threshold is greater than the third threshold.

18. A non-transitory computer-readable storage medium having stored thereon computer-executable instructions that, when executed by a processor, perform steps of:
acquiring an image of a user;
determining at least one appearance attribute of the user according to the image of the user;
determining appearance grade information of the user according to the at least one appearance attribute of the user; and
determining a corresponding recommended product according to the appearance grade information of the user.

19. The non-transitory computer-readable storage medium of claim 18,
wherein the step of determining at least one appearance attribute of the user according to the image of the user comprises steps of:
processing the image of the user by using a neural network to determine the at least one appearance attribute of the user;
wherein the step of determining appearance grade information of the user according to the at least one appearance attribute of the user comprises steps of:
determining a sub-parameter value corresponding to each of the at least one appearance attribute of the user according to the appearance attribute to obtain at least one sub-parameter value of the at least one appearance attribute of the user, wherein there is a preset Gaussian distribution relationship between the appearance attribute and the sub-parameter value;
determining the appearance grade information of the user according to the at least one sub-parameter value of the at least one appearance attribute of the user;
wherein the step of determining a corresponding recommended product according to the appearance grade information of the user comprises a step of:
determining product grade information of the recommended product according to the appearance grade information of the user, wherein there is a positive correlation between the appearance grade information and the product grade information.

20. The non-transitory computer-readable storage medium of claim 19,
wherein the step of determining a sub-parameter value corresponding to each of the at least one appearance attribute of the user according to the appearance attribute comprises steps of:
determining yi of an appearance attribute i of the user according to the following formula, and determining the sub-parameter value of the appearance attribute i according to yi:
yi=yiₘₐₓ*exp[−(xi−xiₘ)²/Si];
where exp[ ] represents an exponential function with a natural constant e as a base, yiₘₐₓ represents a preset maximum sub-parameter value of the appearance attribute i, xi represents a value of the appearance attribute i, xiₘ represents a preset peak value of a Gaussian distribution relationship corresponding to the appearance attribute i, and Si represents a full width at half maximum value of the Gaussian distribution relationship corresponding to the appearance attribute i;
wherein the step of determining the sub-parameter value of the appearance attribute i according to yi comprises steps of:
taking the sub-parameter value as yi when yi does not meet a preset first exclusion rule;
the first exclusion rule comprises:
taking the sub-parameter value as a first threshold when yi is less than the first threshold;
and/or,
taking the sub-parameter value as a second threshold when yi is greater than the second threshold,
wherein the second threshold is greater than the first threshold;
wherein the step of determining the appearance grade information of the user according to the at least one sub-parameter value of the at least one appearance attribute of the user comprises steps of:
determining an intermediate parameter value according to the at least one sub-parameter value of the at least one appearance attribute of the user; and
taking the appearance grade information as the intermediate parameter value when the intermediate parameter value does not meet a preset second exclusion rule;
the second exclusion rule comprises:
taking the sub-parameter value as a third threshold when the intermediate parameter value is less than the third threshold;
and/or,
taking the sub-parameter value as a fourth threshold when the intermediate parameter value is greater than the fourth threshold,
wherein the fourth threshold is greater than the third threshold.
